(19) United States
(12) Patent Application Publication
(10) Pub. No.: US 2003/0160140 A1
(43) Pub. Date: Aug. 28, 2003

(54) Construction accessory

(76) Inventor: Frank J. Nastase, Odessa, TX (US)

Correspondence Address: Richard R. Ruble, JACKSON WALKER L.L.P., Suite 2100, 112 E. Pecan Street, San Antonio, TX, 78205, US

(21) Appl. No.: 10/373,981

(22) Filed: Feb. 25, 2003

Related U.S. Application Data
(60) Provisional application No. 60/359,759, filed on Feb. 26, 2002.

(51) Int. Cl. E06C 7/14

(52) U.S. Cl. 248/210

(57) ABSTRACT

The present invention provides a receptacle holder capable of being removably secured to a ladder at one end and removably secured to a construction accessory at a second end to provide increased efficiency and convenience for the construction worker. The present invention provides a first fastener and a second fastener, each fastener having holes for receiving one or more bolts and an adjustment screw to allow either fastener to attach to virtually any type of ladder or accessory. The fasteners of the present invention are connected by an elongated metal shaft. The shaft is threaded so that the lateral spacing between the first and second fasteners may be adjusted to accommodate multiple applications.

This utility application is based upon and claims priority from a provisional patent application, hereby incorporated herein by reference in its entirety, entitled “Construction Accessory”, Ser. No. 60/359,759, having a filing date of Feb. 26, 2002.

### FIELD OF THE INVENTION

The present invention relates generally to receptacle holders and, more particularly, to a receptacle holder for use in construction applications.

### BACKGROUND OF THE INVENTION

A painter working from a ladder must hold onto a paint brush or paint roller with one hand while securing and manipulating an open paint can resting on the ladder with the other hand. The paint can conventionally rests upon a ladder platform provided for that purpose. Unfortunately, a conventional ladder platform does not include means for securing the paint can against tipping or falling from the ladder. Also conventional ladders often do not include any means for holding a wet paint brush, roller, or painting accessories.

There remains a need for a receptacle holder capable of being removably secured to a ladder and also capable of lending positive assurance to the painter that an open can will not be tipped or dislodged from the ladder during painting. It is thus an object of the present invention to prevent unwanted tipping or dumping of an open paint can from a ladder. A related object of the present invention is to provide a receptacle holder which is capable of attachment to any ladder, regardless of its design, as well as a variety of paint cans.

In addition, there remains a need for a receptacle holder capable of simultaneous attachment to the paint can and the paint brush. Specifically, wet paint brushes may experience a loss of moisture during coffee breaks or other rest periods where the brush is not in use. A receptacle holder capable of suspending the paint brush within the paint during rest periods is required to properly maintain the paint brush.

Yet another object of the invention is to provide a receptacle holder which may be easily disassembled and readily transported from one paint job to another, and yet, which may be quickly and easily assembled for use on the job. A further object is to provide a receptacle holder which has few parts and may be securely fastened to a ladder for use in only a few seconds time.

### SUMMARY OF THE INVENTION

Accordingly, the present invention provides a receptacle holder capable of being removably secured to a ladder at one end and removably secured to a construction accessory at a second end to provide increased efficiency and convenience for the construction worker. The present invention provides a first fastener and a second fastener, each fastener having holes for receiving one or more bolts and an adjustment screw to allow either fastener to attach to virtually any type of ladder or accessory.

The fasteners of the present invention are connected by an elongated tubular member. The tubular member is threaded so that the lateral spacing between the first and second fasteners may be adjusted to accommodate a variety of applications. The present invention is ideally suited to support paint cans or other accessories while utilizing a ladder. In addition, the present invention provides a generally elastic member capable of providing stable attachment for accessories having rounded surfaces, such as a paint brush. This feature of the present invention allows wet brushes to be conveniently suspended inside the paint can during coffee breaks or rest periods. The present invention may also be adjusted to provide a convenient tape dispenser. Upon removal and subsequent reinsertion of one of the fasteners, the tubular member may be used to support and dispense tape or other accessories.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a side elevation view of one embodiment of the present invention.

FIG. 2 is a perspective view of one embodiment of the present invention illustrating simultaneous attachment to both a ladder and a paint can.

FIG. 3 is a perspective view of one embodiment of the present invention illustrating simultaneous attachment to both a paint can and a paint brush.

FIG. 4 is a perspective view of one embodiment of the present invention illustrating the use of the present invention as a combination accessory holder and tape dispenser.

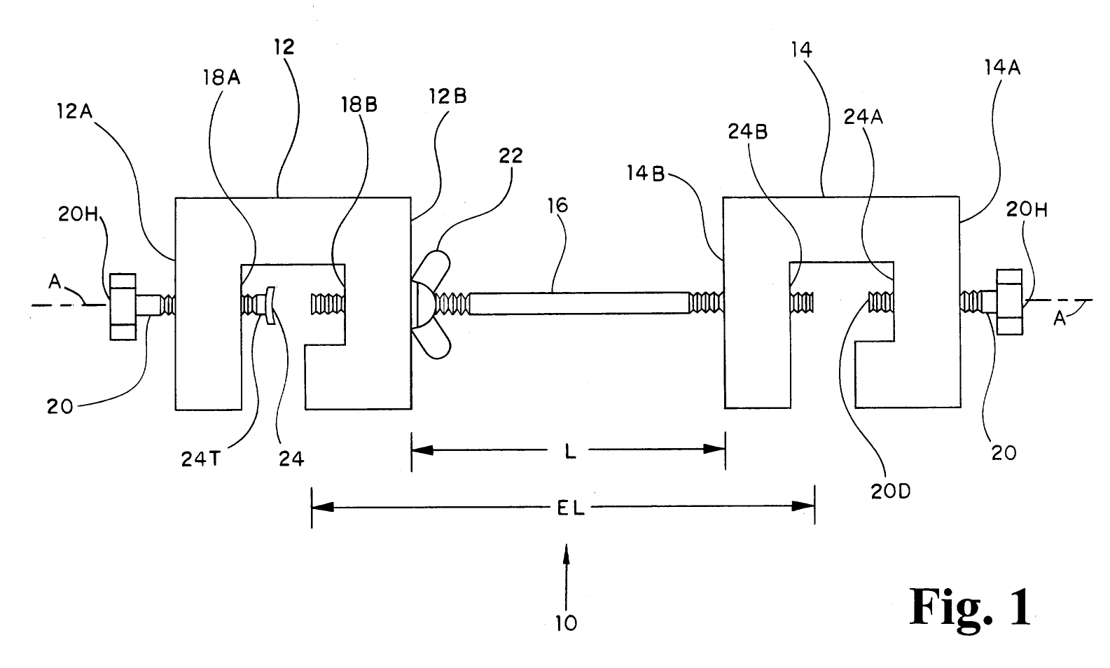

### DETAILED DESCRIPTION OF THE INVENTION

The present invention, as illustrated in the Figures, is herein described as a receptacle holder (10) for supporting accessories during construction applications. The present invention is equipped with a first fastener (12) and a second fastener (14) releasably attached to each other using a tubular member (16).

The first fastener (12) of the present invention has a first end (12A) and a second end (12B). In one embodiment, the first end (12A) of the first fastener (12) defines a hole (18A) for receiving a threaded bolt (20) having a head portion (20H) and a distal portion (20D). Additionally, the second end (12B) of the first fastener (12) defines a hole (18B) for receiving the tubular member (16) such that the first and second fastener, or flattened fastener, (12 and 14, respectively) may be releasably attached. In one embodiment, the tubular member (16) is an elongated metal shaft threaded along its entire length (EL). In another embodiment, the tubular member (16) is equipped with one or more wing nuts or one or more standard ¼ inch nuts (22) to assist the user in tightening the first or second fasteners (12 and 14, respectively), as described further below.

The second fastener (14) of the present invention has a first end (14A) and a second end (14B), each end defining a hole. The hole (24A) defined by the first end (14A) of the second fastener (14) is capable of receiving a threaded bolt (20) having a head portion or thumb screw (20H) and a distal portion (20D). The hole (24B) defined by the second end (14B) of the second fastener (14) is designed to receive the tubular member or all thread spindle (16) so as to allow the first fastener (12) and the second fastener (14) to be releasably attached. In one embodiment, the first and second fastener (12 and 14, respectively) of the present invention have a generally C-shaped configuration and are each rotatable about an axis of rotation (A). It should be noted that the size and shape of each fastener (12 and 14, respectively) may be varied to accommodate virtually any ladder or accessory.

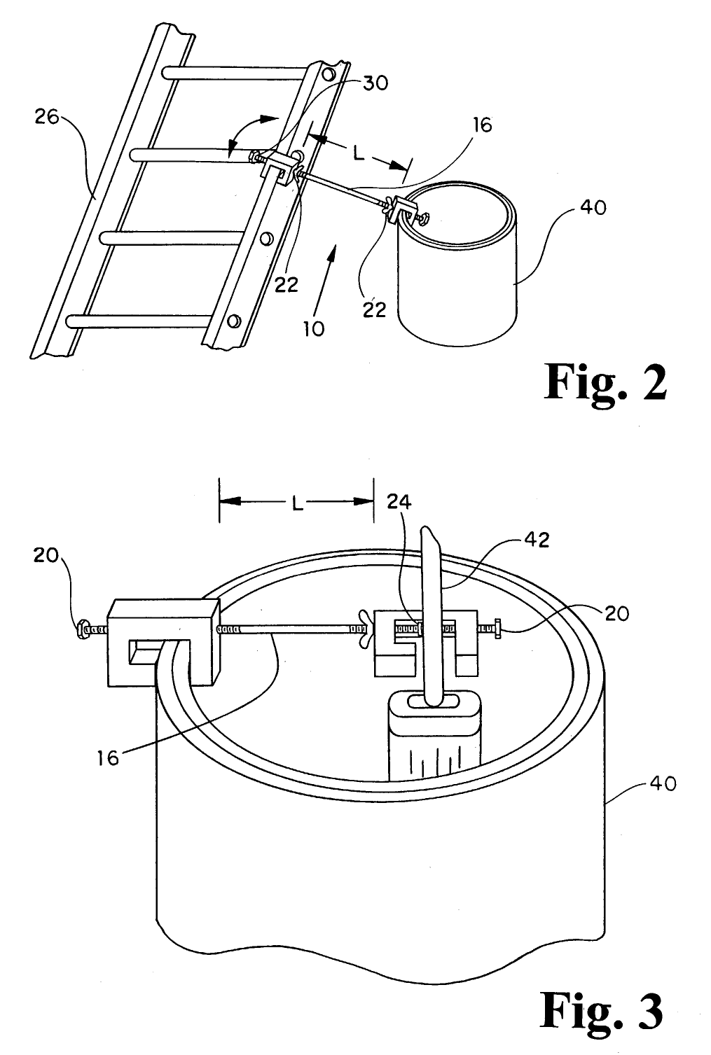

Referring to FIG. 2, the receptacle holder (10) of the present invention is capable of providing convenient access to accessories for a variety of construction applications. For example, the first fastener (12) of the present invention may be placed upon a ladder (26) or other support structure such that the tubular member (16) extends outwardly from the ladder. The first fastener (12) is firmly secured to the ladder (26) by adjusting the threaded bolt (20) and fixing the wing nut (22) in place, as illustrated in FIG. 2. Once the first fastener (12) has been releasably attached to the ladder (26), the user may adjust the lateral spacing (L) between the fastener (12 and 14, respectively) by adjusting the wing nut (22) and/or unthreading the second fastener (14) away from the tubular member (16). This allows the present invention to adapt to the needs of the user, regardless of the size of the accessory or the ladder (26).

Once the desired lateral spacing (L) has been achieved, the user may place the accessory upon the second fastener (14) such that the accessory may be secured thereto. The present invention is capable of accommodating a variety of accessories including, but not limited to, paint cans (40), paint brushes (42), painting trays, rollers, towels or tools (not shown). In one embodiment, the second fastener (14) is used to secure a paint can (40) to the tubular member (16) and, in turn, to the ladder (26). The receptacle holder (10) of the present invention allows the user easy access to the paint can (40) by firmly securing the first fastener (12) to the ladder (26) and the second fastener (14) to the paint can (40). Further, the user may adjust the lateral spacing (L) of the fastener (12 and 14, respectively) so that the paint can (40) is the desired distance from the ladder (26) or other support structure. In this way, each individual user may adjust the receptacle holder (10) of the present invention in an ergonomically friendly manner.

Referring to FIG. 3, the receptacle holder (10) of the present invention may be utilized to suspend paint brushes (42) within the paint can (40) during coffee breaks or other rest periods. Specifically, the first fastener (12) may be adjusted to fit and releasably attach to any size paint can (40). The lateral spacing (L) of the first (12) and second fastener (14) may be adjusted to allow the paint brush to be suspended anywhere within the paint can (40). This feature of the present invention may be used to prevent the loss of brush moisture during rest periods or to prevent unwanted dripping.

In one embodiment, a generally elastic member (24) capable of attachment to the bolts (20) or tubular member (16) of the present invention is provided. In one embodiment, the elastic member (24) has a generally concave configuration and may be attached to one or more bolts (20) or to either end of the tubular member (16) in order to enhance the abilities of the present invention to secure paint brushes (42) and other rounded accessories. In one embodiment, each elastic member (24) has a generally concave configuration and is equipped with a threaded portion (24T) capable of releasably attaching to either the tubular member (16) or the distal portion of a threaded bolt (20).

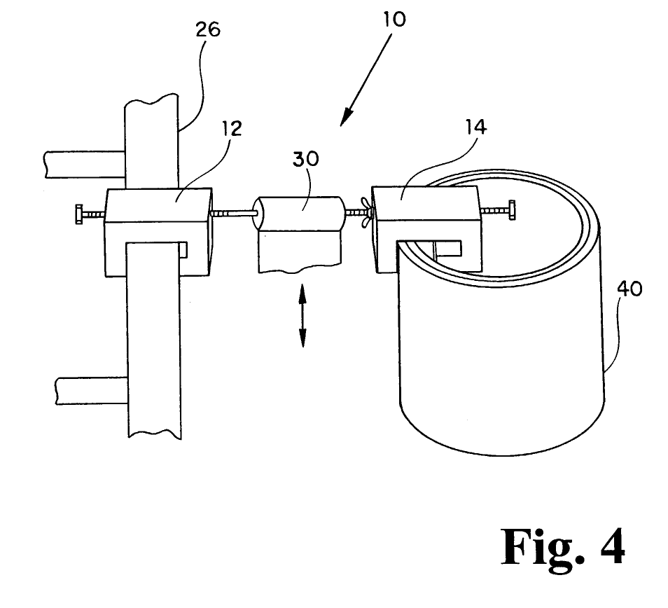

Referring to FIG. 4, the receptacle holder (10) of the present invention may be utilized to support and dispense rolled materials (30). In one embodiment, the second fastener (14) may be unscrewed from the tubular member (16) such that the tubular member resembles a cantilever beam. Rolled materials (30) may then be placed upon the tubular member (16), as illustrated in FIG. 4. The second fastener is then reattached to the tubular member to allow the receptacle holder (10) of the present invention to function as both an accessory holder and as a rolled material dispenser. In one embodiment, the receptacle holder of the present invention is utilized to support and dispense adhesive products, such as tape.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A receptacle holder for supporting one or more construction accessories comprising:
a first fastening means for securing a first portion of said holder to a ladder; and
a second fastening means for securing a second portion of said holder to said construction accessory, said second fastening means releasably attached to said first fastening means by an elongated member.

2. The receptacle holder of claim 1, wherein said elongated member is threaded along its entire length to allow 1) the spacing of said first fastening means relative to said second fastening means to be adjusted and 2) independent rotation of said first fastening means and said second fastening means about said elongate member.

3. The receptacle holder of claim 1, wherein a first end of said first fastening means comprises walls defining a cavity for receiving a first bolt having a proximal head portion and a distal end portion.

4. The receptacle holder of claim 3, wherein a second end of said first fastening means comprises an arcuate surface for retaining said ladder in conjunction with said distal end of said first bolt.

5. The receptacle holder of claim 3, wherein said first bolt is at least partially threaded such that said first fastening means is rotatable about said first bolt.

6. The receptacle holder of claim 3, wherein a first end of said second fastening means comprises walls defining a second cavity for receiving a second bolt having a proximal head portion and a distal end portion.

7. The receptacle holder of claim 6, wherein said second bolt is at least partially threaded such that said second fastening means is rotatable about said second bolt.

8. The receptacle holder of claim 6, wherein a second end of said second fastening means comprises an arcuate surface for retaining said accessory in conjunction with said distal end of said second bolt.

9. The receptacle holder of claim 6, further comprising a generally elastic member for releasably attaching to said distal end of said first bolt or a first end of said elongated member.

10. The receptacle holder of claim 6, further comprising a generally elastic member for releasably attaching to said distal end of said second bolt or a second end of said elongated member.

11. A receptacle holder for supporting one or more construction accessories comprising:
a first fastening means for securing a first portion of said holder to a first construction accessory; and
a second fastening means for securing a second portion of said holder to a second construction accessory, said second fastening means releasably attached to said first fastening means by an elongated member.

12. The receptacle holder of claim 11, wherein said elongated member is threaded along its entire length to allow 1) the spacing of said first fastening means relative to said second fastening means to be adjusted and 2) independent rotation of said first fastening means and said second fastening means about said elongate member.

13. The receptacle holder of claim 11, wherein a first end of said first fastening means comprises walls defining a cavity for receiving a first bolt having a proximal head portion and a distal end portion.

14. The receptacle holder of claim 13, wherein a second end of said first fastening means comprises an arcuate surface for retaining said first construction accessory in conjunction with said distal end of said first bolt.

15. The receptacle holder of claim 13, wherein said first bolt is at least partially threaded such that said first fastening means is rotatable about said first bolt.

16. The receptacle holder of claim 13, wherein a first end of said second fastening means comprises walls defining a second cavity for receiving a second bolt having a proximal head portion and a distal end portion.

17. The receptacle holder of claim 16, wherein said second bolt is at least partially threaded such that said second fastening means is rotatable about said second bolt.

18. The receptacle holder of claim 16, wherein a second end of said second fastening means comprises an arcuate surface for retaining said second accessory in conjunction with said distal end of said second bolt.

19. The receptacle holder of claim 16, further comprising a generally elastic member for releasably attaching to said distal end of said first bolt or a first end of said elongated member.

20. The receptacle holder of claim 16, further comprising a generally elastic member for releasably attaching to said distal end of said second bolt or a second end of said elongated member.
